(19) United States
(12) Patent Application Publication
(10) Pub. No.: US 2026/0032367 A1
(43) Pub. Date: Jan. 29, 2026

(54) ACOUSTIC EXCITATION DEVICE

(71) Applicants: Pioneer Corporation, Bunkyo-ku, Tokyo (JP); Tohoku Pioneer Corporation, Tendo-shi, Yamagata (JP)

(72) Inventors: YOSUKE SATAKE, Yamagata (JP); YU WATANABE, Yamagata (JP); TAKUMI FUKUOKA, Yamagata (JP); ARAKI SHOJI, Yamagata (JP)

(21) Appl. No.: 19/135,312

(22) PCT Filed: Feb. 27, 2023
(86) PCT No.: PCT/JP2023/007004

§ 371 Date: Jun. 3, 2025

(51) Int. Cl. H04R 1/02; H04R 9/02; H04R 9/04

(52) U.S. Cl. CPC H04R 1/02; H04R 9/025; H04R 9/04

(57) ABSTRACT

An acoustic excitation device includes a frame fixed to a panel material, an excitation unit including a cylindrical body and a magnetic circuit unit attached to an inner circumference of the cylindrical body, and a drip-proof cover that prevents water droplets falling from above the panel material, wherein the drip-proof cover is attached to the excitation unit.

### TECHNICAL FIELD

The present invention relates to an acoustic excitation device.

### BACKGROUND

There are known excitation devices that reproduce sound by vibrating a panel material. As an example, the Patent Document 1 discloses an excitation device that is disposed between a ceiling interior material and an exterior panel of a vehicle to output sound into the vehicle cabin by vibrating the ceiling interior material.

An excitation device (2) illustrated in FIG. 5 of the Patent Document 1 includes a magnetic circuit unit (4), a cylindrical body (5) that holds the magnetic circuit unit (4), a coil (32) arranged in a magnetic gap of the magnetic circuit unit (4), a bobbin unit (21m) around which the coil (32) is wound, a coil support member (21) that includes the bobbin unit (21m), a coupler (22) to which the coil support member (21) is attached and which is fixed to a ceiling interior material (50), a first damper (33) that connects the bobbin unit (21m) and the cylindrical body (5), and a second damper (34) that connects the cylindrical body (5) and the coil support member (21).

### RELATED ART

### Patent Document

Patent Document 1: JP2021029005 A

### SUMMARY OF THE INVENTION

### Problem to be Solved by the Invention

In the above-described excitation device (2) illustrated in FIG. 5 of the Patent Document 1, condensation water that falls from the outer panel of the vehicle may adhere to the second damper (34), and it would be desirable to add a drip-proof structure. However, it was not easy to add the drip-proof structure that fits into the narrow space between the ceiling interior material and the outer panel of the vehicle.

Therefore, one of the objects to be achieved by the present invention is to add a drip-proof structure to an acoustic excitation device that vibrates a panel material while preventing an increase of the dimension in the height direction.

### Solution to Problem

An acoustic excitation device according to the present invention includes a frame fixed to a panel material, an excitation unit including a cylindrical body and a magnetic circuit unit attached to an inner circumference of the cylindrical body, a voice coil arranged in a magnetic gap of the magnetic circuit unit, a bobbin around which the voice coil is wound, a first damper that connects the cylindrical body and the bobbin, a second damper that connects the cylindrical body and the frame, and a drip-proof cover that prevents water droplets falling from above the panel material from adhering to the second damper, wherein the drip-proof cover is formed in an annular shape with an opening in a center, and is attached to the excitation unit such that the drip-proof cover is disposed on an outer circumference side with respect to the magnetic circuit unit and above the second damper, and an upper portion of the magnetic circuit unit passes through the opening to be arranged above the drip-proof cover.

### BRIEF DESCRIPTION OF THE DRAWINGS

FIG. 1 is a perspective view illustrating an acoustic excitation device according to one embodiment of the present invention.

FIG. 2 is a cross-sectional view taken along line A-A of FIG. 1.

FIG. 3 is an enlarged view of a main portion of FIG. 2.

FIG. 4 is an exploded view of the acoustic excitation device of FIG. 1.

FIG. 5 is a plan view illustrating a state before a base and a flange of FIG. 4 are assembled.

FIG. 6 is a plan view illustrating a state after the base and the flange of FIG. 5 are assembled.

FIG. 7 is a view for explaining the assembly structure of the base and the flange of FIG. 5.

### MODES FOR CARRYING OUT THE INVENTION

An embodiment of the present invention will be described below. An acoustic excitation device according to an embodiment of the present invention includes a frame fixed to a panel material, an excitation unit including a cylindrical body and a magnetic circuit unit attached to an inner circumference of the cylindrical body, a voice coil arranged in a magnetic gap of the magnetic circuit unit, a bobbin around which the voice coil is wound, a first damper that connects the cylindrical body and the bobbin, a second damper that connects the cylindrical body and the frame, and a drip-proof cover that prevents water droplets falling from above the panel material from adhering to the second damper, wherein the drip-proof cover is formed in an annular shape with an opening in a center, and is attached to the excitation unit such that the drip-proof cover is disposed on an outer circumference side with respect to the magnetic circuit unit and above the second damper, and an upper portion of the magnetic circuit unit passes through the opening to be arranged above the drip-proof cover. As described above, in the present invention, the drip-proof cover prevents water droplets falling from above the panel material from adhering to the second damper. Additionally, because the drip-proof cover is formed into the annular shape with the opening in the center and the drip-proof cover is attached to the excitation unit, the increase of the dimension in the height direction can be alleviated.

Additionally, it is preferable that an upper surface of the drip-proof cover is formed to slope downward from an inner circumference side to an outer circumference side. With such a formation, water droplets adhering to the drip-proof cover can be guided to the outer circumference side and dropped onto the panel material side.

Additionally, it is preferable that the cylindrical body includes a cylindrical portion and a flange portion extending toward an outer side of the cylindrical portion from a lower end of the cylindrical portion, an outer circumference portion of the first damper is superimposed on a lower surface of the flange portion, an inner circumference portion of the second damper is superimposed on an upper surface of the flange portion, and the magnetic circuit unit and the drip-proof cover are attached to the cylindrical portion. With this configuration, the increase of the dimension in the height direction can be furthermore alleviated.

### Embodiment

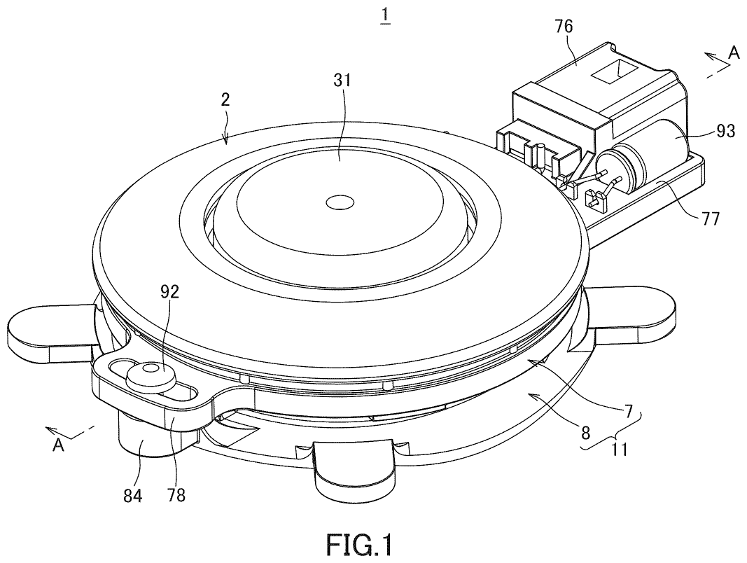

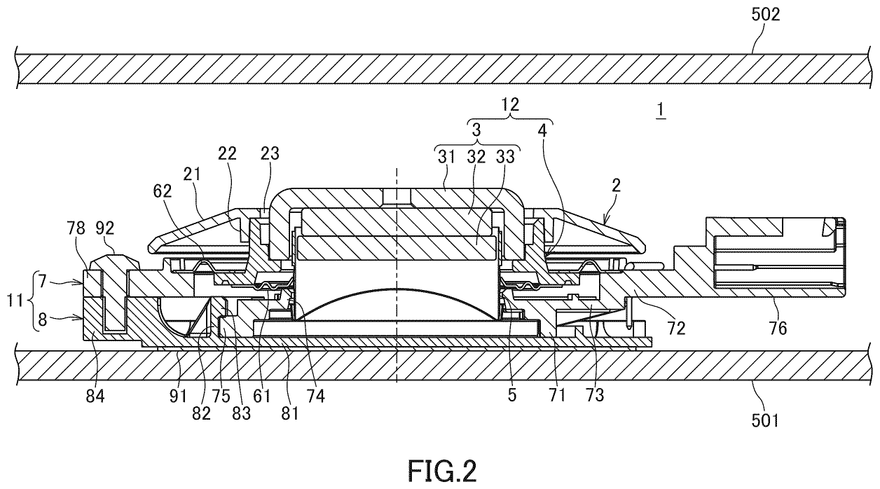

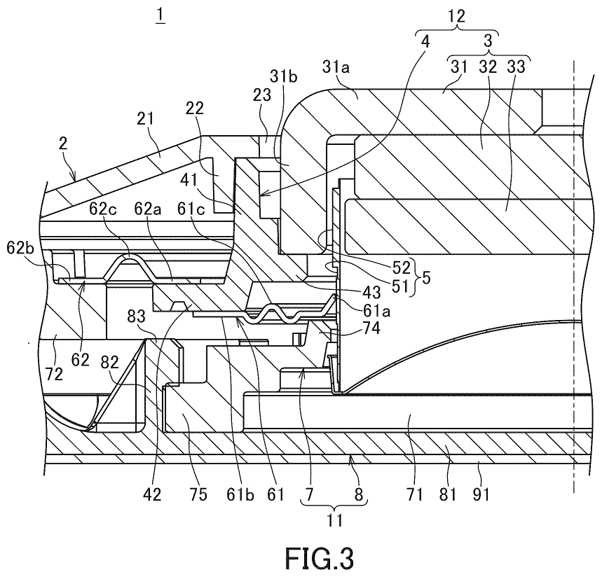

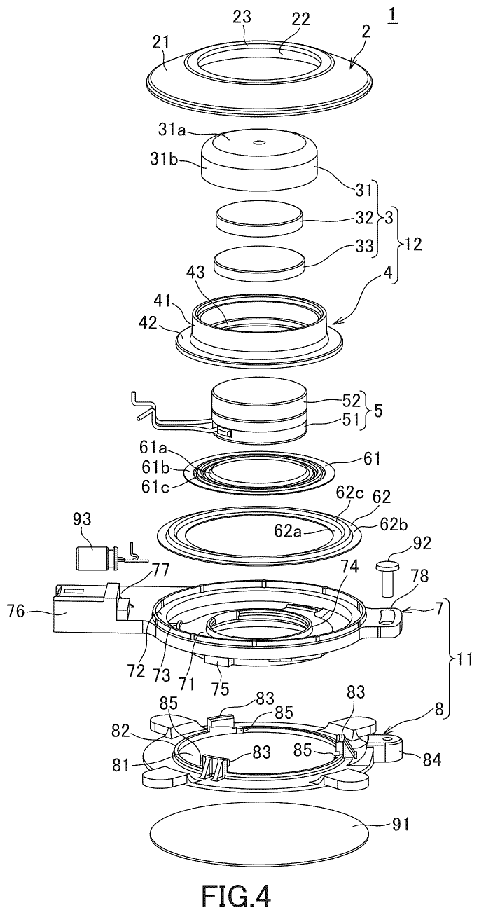

FIGS. 1 to 4 illustrate an acoustic excitation device 1 according to one embodiment of the present invention. The acoustic excitation device 1 is installed between a ceiling interior material (corresponding to a panel material) 501 and an exterior panel 502 of a vehicle, and outputs sound into the vehicle cabin by vibrating the ceiling interior material 501.

In this specification, the directions, “above/upper/upward” and “below/lower/downward”, are used with reference to an orientation in which the acoustic excitation device 1 is installed between the ceiling interior material 501 and the exterior panel 502 of a vehicle.

The acoustic excitation device 1 includes a frame 11, an excitation unit 12, a voice coil assembly 5 in which a voice coil 52 is wound around a bobbin 51, a first damper 61, a second damper 62, a drip-proof cover 2, and a capacitor 93.

The frame 11 includes a base 8 made of synthetic resin that is fixed to the ceiling interior material 501 via a double-sided tape 91, and a flange 7 made of synthetic resin that is attached to the base 8.

The base 8 includes a plate portion 81 which is superimposed on the ceiling interior material 501 via the double-sided tape 91, a rib 82 in an annular shape formed on the upper surface of the plate portion 81, three claws 83 connected to the rib 82, a bolt fastening portion 84 connected to the outer circumference portion of the plate portion 81, and three protruding portions 85 which protrude inward from the rib 82.

The flange 7 includes a support portion 71 in an annular shape that is superimposed on the upper surface of the plate portion 81 on the inside of the rib 82, a first damper attachment portion 74 that is connected to the support portion 71 and extends upward and inward, three protruding portions 75 that protrude outwardly from the outer circumference portion of the support portion 71, a second damper attachment portion 72 in an annular shape that surrounds the support portion 71, a connection portion 73 that connects the support portion 71 and the second damper attachment portion 72, a connector portion 76 that is connected to the outer circumference portion of the second damper attachment portion 72, a capacitor attachment portion 77, a bolt fastening portion 78, and the like.

The connector portion 76 connects the voice coil 52 to an audio current supply source provided outside. The capacitor attachment portion 77 is a portion where the capacitor 93 is attached. The capacitor 93 is interposed between the audio current supply source and the voice coil 52.

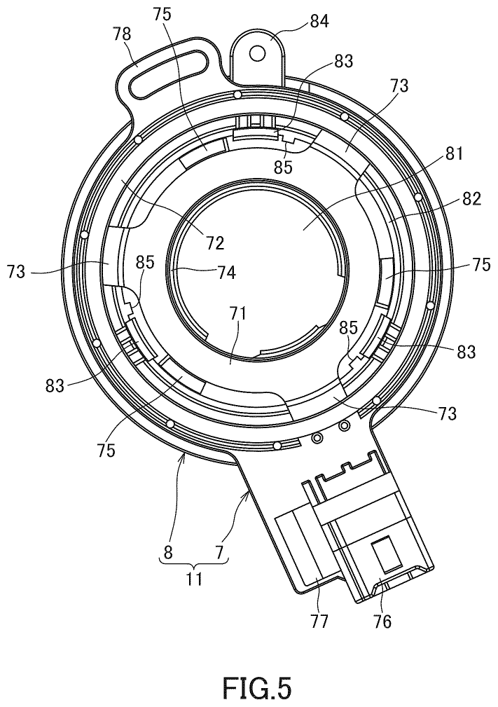

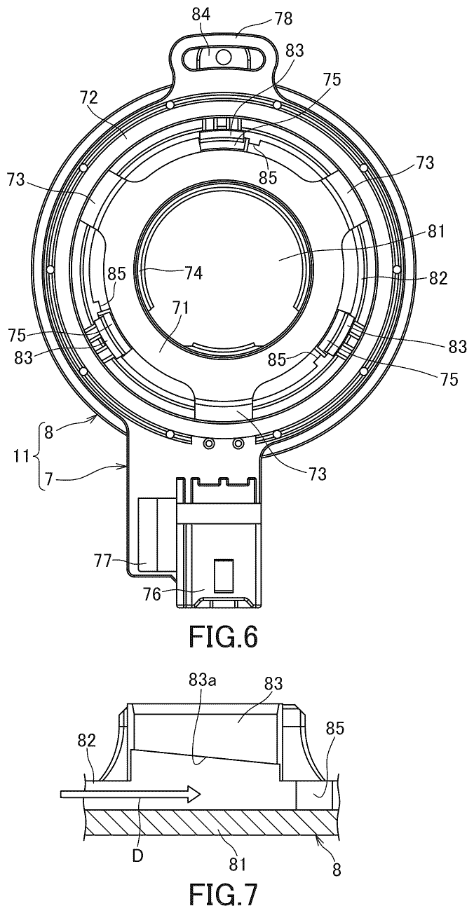

The base 8 and the flange 7 are assembled to each other by turning the flange 7 clockwise in such a state that the base 8 and the flange 7 are superimposed as illustrated in FIG. 5, so that the protruding portions 75 of the flange 7 enter grooves 83a of the respective claws 83 of the base 8 as illustrated in FIG. 6. As illustrated in FIG. 7, the grooves 83a of the claws 83 are formed so that its width gradually narrows along the insertion direction (arrow D) of the protruding portion 75. Therefore, when the flange 7 is turned, the fit between the claws 83 and the protruding portions 75 gradually becomes tighter. When the flange 7 is further rotated, the protruding portions 75 abut against the protruding portions 85. After the base 8 and the flange 7 are assembled in this manner, a bolt 92 is fastened to the bolt fastening portions 84 and 78 as a locking mechanism to fix the base 8 and the flange 7 together.

In order to repair the acoustic excitation device 1, the flange 7 can be easily separated from the base 8 by removing the bolt 92 and turning the flange 7 counterclockwise.

The excitation unit 12 includes the cylindrical body 4 made of synthetic resin and the magnetic circuit unit 3 attached to the inner circumference side of the cylindrical body 4.

The cylindrical body 4 has a cylindrical portion 41, a flange portion 42 extending from a lower end of the cylindrical portion 41 to the outer side of the cylindrical portion 41, and a protruding portion 43 protruding from the inner circumferential surface of the cylindrical body 4.

The magnetic circuit unit 3 includes a yoke 31 made of a magnetic material, a magnet 32 in a disk shape, and a plate 33 in a disk shape made of a magnetic material. The yoke 31 includes an overlapping portion 31a in a disk shape that is superimposed on the magnet 32, and a side wall 31b in a cylindrical shape that hangs down from the outer edge portion of the overlapping portion 31a. The magnet 32 is superimposed on the lower surface of the overlapping portion 31a on the inside of the side wall 31b, and the plate 33 is superimposed on the lower surface of the magnet 32 on the inside of the side wall 31b. A magnetic gap is formed between the inner circumferential surface of the side wall 31b and the outer circumferential surface of the plate 33.

The magnetic circuit unit 3 is attached to the inner circumference side of the cylindrical portion 41 with the lower end of the side wall 31b of the yoke 31 being in contact with the protruding portion 43 of the cylindrical body 4.

The first damper 61 is attached to the outer circumferential surface of the bobbin 51, so that the voice coil assembly 5 is supported by the first damper 61. An upper portion of the bobbin 51 and the voice coil 52 are disposed within the magnetic gap of the magnetic circuit unit 3.

The first damper 61 is made of a material in which a woven fabric is impregnated with resin, and is formed in an annular shape. The first damper 61 includes an inner circumference portion 61a bonded to the bobbin 51, an outer circumference portion 61b superimposed on and bonded to the lower surface of the flange portion 42 of the cylindrical body 4, and a wavy portion 61c provided between the inner circumference portion 61a and the outer circumference portion 61b. In this way, the first damper 61 connects the inner circumference side of the cylindrical body 4 to the bobbin 51.

The first damper attachment portion 74 of the flange 7 is bonded to the inner circumference portion 61a of the first damper 61. The first damper attachment portion 74 of the flange 7 is bonded to the outer circumferential surface of the bobbin 51.

The second damper 62 is made of a material in which a woven fabric is impregnated with resin, and is formed in an annular shape. The second damper 62 includes an inner circumference portion 62a that is superimposed on and bonded to the upper surface of the flange portion 42 of the cylindrical body 4, an outer circumference portion 62b that is superimposed on and bonded to the second damper attachment portion 72 of the flange 7, and a curved portion 62c that is provided between the inner circumference portion 62a and the outer circumference portion 62b. The curved portion 62c is formed to have a semicircular cross section that bulges upward. In this way, the second damper 62 connects the outer circumference side of the cylindrical body 4 to the flange 7. The second damper 62 is positioned on the outer side with respect to the first damper 61.

As described above, the cylindrical body 4 is supported by both the first damper 61 arranged on its inner circumference side and the second damper 62 arranged on its outer circumference side. By employing such a configuration, rolling of the excitation unit 12 can be alleviated, and the durability of the acoustic excitation device 1 can be improved.

The drip-proof cover 2 is for preventing water droplets (condensation water) that have fallen from the exterior panel 502 from adhering to the second damper 62, and the drip-proof cover 2 is attached to the cylindrical body 4 in this example. The drip-proof cover 2 is made of synthetic resin, and includes a cover main body 21 and an attachment portion 22. The cover main body 21 is formed in an annular shape with an opening in the center. The opening in the center of the cover main body 21 is denoted by reference numeral 23. The attachment portion 22 is formed in a cylindrical shape, and hangs down from the lower surface of the cover main body 21 on the outer circumference of the opening 23. The attachment portion 22 is attached to the upper end portion of the outer circumferential surface of the cylindrical portion 41.

The drip-proof cover 2 is disposed on an outer circumference side with respect to the magnetic circuit unit 3 and above the second damper 62. An upper portion of the magnetic circuit unit 3 passes through the opening 23 of the drip-proof cover 2 to be arranged above the drip-proof cover 2. An upper surface of the cover main body 21 is formed to slope downward from the inner circumference side to the outer circumference side. Accordingly, water droplets adhering to the drip-proof cover 2 can be guided to the outer circumference side and dropped onto the ceiling interior material 501.

The acoustic excitation device 1 is installed in a narrow space between the ceiling interior material 501 and the exterior panel 502 of a vehicle, and when the drip-proof cover 2 is provided, there is a restriction on the dimension in the height direction. In order to prevent an increase of the dimension in the height direction, the drip-proof cover 2 explained above is not a cover that completely covers the excitation unit 12, but rather has a minimal and simple configuration for covering the second damper 62. Specifically, as described above, the drip-proof cover 2 has such a structure that the cover main body 21 is formed into an annular shape with the opening in the center, and the drip-proof cover 2 has a height that does not exceed the upper portion of the magnetic circuit unit 3 (the overlapping portion 31a of the yoke 31), and this drip-proof cover 2 is attached to the cylindrical body 4.

Furthermore, in order to prevent the cylindrical body 4 from increasing in the dimension in the height direction, the cylindrical body 4 is composed of the cylindrical portion 41, the flange portion 42, and the protruding portion 43. The first damper 61 is attached to the lower surface of the flange portion 42, the second damper 62 is attached to the upper surface of the flange portion 42, the magnetic circuit unit 3 is attached to the inner circumference side of the cylindrical portion 41, and the attachment portion 22 of the drip-proof cover 2 is attached to the outer circumferential surface of the cylindrical portion 41. According to this configuration, the overall dimension of the acoustic excitation device 1 in the height direction can be prevented from increasing.

Furthermore, because the cover main body 21 is formed in the annular shape with the opening in the center, the weight of the drip-proof cover 2 can be reduced. Additionally, because the upper portion of the magnetic circuit unit 3 is exposed through the opening 23 of the cover main body 21, heat dissipation can be improved.

In the acoustic excitation device 1 with the above-described configuration, the excitation unit 12 primarily vibrates using the electromagnetic force as a driving force generated by an audio current supplied to the voice coil 52, and the ceiling interior material 501 is vibrated via the frame 11, thereby outputting audio into the vehicle cabin.

Although the excitation unit 12 includes a cylindrical body 4 and a magnetic circuit unit 3 in the embodiment explained above, the excitation unit according to the present invention may include a cylindrical body, a magnetic circuit unit, and a component other than the cylindrical body and the magnetic circuit unit. Furthermore, although the drip-proof cover 2 is attached to the cylindrical body 4 in the embodiment explained above, the drip-proof cover may be attached to the magnetic circuit unit or may be attached to a component other than the cylindrical body and the magnetic circuit unit in the present invention.

Furthermore, in the embodiment explained above, although the acoustic excitation device 1 is attached to the ceiling interior material 501 of a vehicle, the acoustic excitation device of the present invention can be attached not only to the ceiling interior material of a vehicle, but also to various panel materials that can output sound by vibrating them.

Although the embodiment of the present invention has been described in detail above with reference to the drawings, the specific configuration is not limited to the embodiment, and the present invention includes design changes within the scope of the gist of the present invention. The embodiment shown with the above figures can be combined with each other as long as there is no particular contradiction or problem in their purpose and configuration. Additionally, the contents of each figure can be an independent embodiment, and the embodiment of the present invention is not limited to one embodiment obtained by combining the figures.

### LIST OF REFERENCE SIGNS

1 acoustic excitation device
2 drip-proof cover
3 magnetic circuit unit
4 cylindrical body
7 flange
8 base
11 frame
12 excitation unit
51 bobbin
52 voice coil
61 first damper
62 second damper
501 ceiling interior material (panel material)
502 exterior panel

1. An acoustic excitation device comprising:
a frame fixed to a panel material;
an excitation unit including a cylindrical body and a magnetic circuit unit attached to an inner circumference of the cylindrical body; and
a drip-proof cover that prevents water droplets falling from above the panel material,
wherein the drip-proof cover is attached to the excitation unit.

2. The acoustic excitation device according to claim 1, wherein an upper surface of the drip-proof cover is formed to slope downward from an inner circumference side toward an outer circumference side.

3. The acoustic excitation device according to claim 4, wherein the cylindrical body includes a cylindrical portion and a flange portion extending toward an outer side of the cylindrical portion from a lower end of the cylindrical portion,
an outer circumference portion of the first damper is superimposed on a lower surface of the flange portion,
an inner circumference portion of the second damper is superimposed on an upper surface of the flange portion, and
the magnetic circuit unit and the drip-proof cover are attached to the cylindrical portion.

4. The acoustic excitation device according to claim 1, further comprising:
a voice coil arranged in a magnetic gap of the magnetic circuit unit;
a bobbin around which the voice coil is wound;
a first damper that connects the cylindrical body and the bobbin; and
a second damper that connects the cylindrical body and the frame,
wherein the drip-proof cover is disposed above the second damper.

5. The acoustic excitation device according to claim 1, wherein the drip-proof cover is formed in an annular shape with an opening in a center, such that the drip-proof cover is disposed on an outer circumference side with respect to the magnetic circuit unit.

6. The acoustic excitation device according to claim 2, wherein an upper portion of the magnetic circuit unit passes through the opening to be arranged above the drip-proof cover.
